(19) United States
(12) Patent Application Publication
(10) Pub. No.: US 2012/0037706 A1
(43) Pub. Date: Feb. 16, 2012

(54) RFID PROXIMITY CARD HOLDER WITH FLUX DIRECTING MEANS

(76) Inventor: Fred HOURANI, Blainville (CA)

(21) Appl. No.: 12/857,037

(22) Filed: Aug. 16, 2010

(51) Int. Cl. G06K 7/01

(52) U.S. Cl. 235/486

(57) ABSTRACT

A card holder for an RFID proximity card having a coil loop antenna with an area for interfacing with a flux generating RFID proximity card reader. The card holder includes a flux directing means; and a housing for containing the flux directing means and receiving the RFID proximity card. When the RFID proximity card is received within the housing, the flux directing means influences the flux generated by the RFID proximity reader such that the flux is directed to within the area of the coil loop antenna.

### FIELD OF THE INVENTION

The present invention relates to an RFID proximity card holder with magnetic flux directing means. In particular, there is provided an RFID proximity card holder comprising a magnetic flux directing means having a magnetic material for directing magnetic flux generated by a contactless interface to within the area of an RFID proximity card antenna loop.

### BACKGROUND OF THE INVENTION

RFID proximity cards, or contactless smartcards, have become a widely used form of contactless rechargeable type smartcard for intelligent access control and payment systems, particularly in the area of mass public transportation, where fast transactions and ease of handling are desired. The prevalent type of contactless smartcards used for such systems are generally powered by and communicate with a contactless interface, or a proximity card reader, according to resonant energy transfer operating principles. In particular, such near field wireless transmission of energy operates by producing an alternating magnetic field generated by sinusoidal current flowing through a card reader antenna loop such that an RFID proximity card within the alternating magnetic field will have an alternating current induced in its loop antenna to thereby supply power to the RFID smartcard circuitry. Typically, for such operation, a proximity card must be placed within a region of approximately zero to three inches from a reader and be parallel thereto such that the magnetic flux emitted by the reader passes through the antenna loop area of the proximity card. Consequentially, it is well known that the quality of this inductive coupling between the antennas of a reader and a proximity card is critical to ensuring quality energy transfer.

However, one drawback associated with such near field wireless energy transmission is that a sufficient electromagnetic flux passing through the card antenna coil necessary to power the smartcard electronics is only obtained when the proximity card has a well defined orientation relative to the flux lines generated by the reader. When the position of the proximity card is deviated from this optimal orientation, the flux passing through the area of a card antenna loop rapidly decreases thereby rendering the proximity card powerless and useless until a sufficient orientation is found. Proper positioning of a proximity card relative to the lines of flux generated by a reader may be especially difficult to attain and maintain in real world operation, such as in mass transit wherein commuters position cards over a reader at various angles with their hands or position bags and purses containing such cards. This drawback presents serious repercussions, notably regarding high volume transaction situations, for example at mass transit contactless card reader stations located on bus or subway access points, wherein recognition of an RFID proximity card is needed to be accomplished in the shortest amount of time. Prolonged reading times at a contactless card reader station due to improper card orientation or distance has a compounding effect when multiple cards experience such problems, leading to increases in boarding times and ultimately disgruntle commuters.

Various manners to alleviate these drawbacks are known and involve focusing and concentrating magnetic flux to within the area of the antenna coil of a proximity card to thereby increase operating distance, reduce the effect of a less than optimal card orientation with respect to the reader, and ultimately improve the power transfer necessary for a proximity card to operate. In particular, it is generally known that employing a magnetic material for manipulating the magnetic flux generated by a card reader is able overcome these drawbacks.

Although the prior art teaches of a wide variety of such magnetic flux focusing means to improve the magnetic coupling between a card loop antenna and a reader antenna to thereby ensure a sufficient degree of flux is passed within a card antenna loop area while at different orientations and distances, current teachings of focusing means tend towards the integration of magnetic materials into the substrate of a proximity tag, with the particular objective of negating counter acting magnetic fields generated by eddy current when an RFID tag is in proximity to a metallic surface. Such integration, however, increases the fabrication costs, bulkiness, and weight of a RFID proximity card. Still, other teachings involve shields comprising magnetic materials being formed in a permanent manner to the substrate of a proximity card. However, due to the high failure rate of proximity cards, integrating magnetic material within the substrate of a proximity card may be costly, particularly for the mass transportation market where cards are easily lost and fail regularly due to the abuse endured from daily handling.

Furthermore, some forms of contactless smartcards are a dual interface type and comprise an additional communication interface in the form of a mechanical contact area comprising metallic contacts on the face of a smartcard which are connected to a microchip embedded in the substrate body of the smartcard. Smartcards with these types of interfaces may to be physically inserted into a mechanical acceptance device to align these contacts with the contacts of a mechanical reader to thereby create a communication link.

What is therefore needed, and an object of the present invention, is a flux directing means for an RFID proximity card which enables improved interrogation orientation deviation and reading distance of an RFID proximity smartcard by an RFID reader by providing a magnetic induction coupling enhancing means capable of being non-permanently retrofitted to an existing RFID proximity smartcard. In particular, the magnetic coupling means is able to be removed from the smartcard such that an RFID proximity smartcard may continue to be employed with existing mechanical contact reading machines for charging, reading, and the like.

Still further, contactless smartcard durability is known to depend on the quality of the bond between the embedded antenna and a smartcard microcontroller. Such a bond is prone to breakage should a card be subjected to excessive bending and torsion flexing when, notably, card holders attempt to use their card by pressing the card on a card reader, and from the daily handling and storing of a card in a purse, pocket, wallet, bag, or the like. Therefore, these factors may impact or significantly reduce the readability and life span of an RFID proximity smartcard.

What is therefore needed, and yet another object of the present invention, is a non-permanent smartcard holder that protects an RFID proximity card from day-to-day wear and tear and which simultaneously improves magnetic coupling between a card and a card reader.

### SUMMARY OF THE INVENTION

More specifically, in accordance with the present invention, there is provided a card holder for an RFID proximity card comprising a coil loop antenna with an area for interfacing with a flux generating RFID proximity card reader, the card holder comprising: a flux directing means; and a housing for containing said flux directing means and receiving the RFID proximity card; wherein when the RFID proximity card is received within said housing, said flux directing means influences the flux generated by the RFID proximity reader such that the flux is directed to within the area of the coil loop antenna.

### BRIEF DESCRIPTION OF THE DRAWINGS

In the appended drawings:

FIG. 1 is a perspective view of a known contactless smartcard system;

FIG. 2 is a top cross-sectional view of an RFID proximity card of the contactless smartcard system of FIG. 1 taken along the line 1-1;

FIG. 3 is a top perspective view of an RFID proximity card holder with flux directing means in accordance with an illustrative embodiment of the present invention;

FIG. 4 is a bottom perspective view of an RFID proximity card holder with flux directing means of FIG. 3;

FIG. 5 is a bottom perspective view of an RFID proximity card holder with flux directing means of FIG. 3 having a proximity card received therein;

FIG. 6 is a top cross-sectional view of a RFID proximity card of a contactless smartcard system of FIG. 1 taken along the line 1-1 illustrating the position of a flux directing means of FIG. 3;

FIG. 7 is a side view of the contactless smartcard system of FIG. 1 illustrating magnetic flux passing through the antenna loop area of an RFID proximity card; and

FIG. 8 is a side view of the contactless smartcard system of FIG. 1 illustrating magnetic flux passing through the antenna loop area of an RFID proximity card as directed by the RFID proximity card holder with flux directing means of FIG. 3.

### DESCRIPTION OF ILLUSTRATIVE EMBODIMENTS

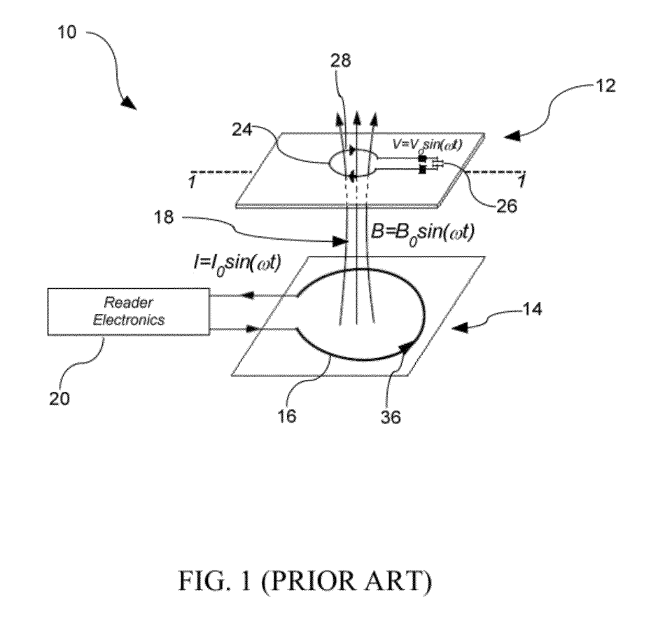

Referring to FIG. 1, a contactless smartcard system in accordance with an illustrative embodiment of the present invention, generally referred to using the reference number 10 is described. In particular, the contactless smartcard system 10 comprises an RFID proximity card 12 and a contactless interface 14, also generally known in the art as a card reader or a card interrogator, for powering and communicating with the proximity card 12. Generally, the reader 14 comprises a reader antenna coil 16 that provides energy in the form of a generated magnetic flux 18 and/or for communication with an RFID proximity card 12 when brought into proximity with the reader 14, as well as electronics 20 to process validation and other information transmitted from the RFID proximity card 12. In accordance with the illustrative embodiment of the present invention, when the contactless smartcard system 10 is used for public transit applications, the reader 14 is commonly located in fare boxes, ticket machines, turnstiles, and station platforms as a standalone unit. In accordance with another illustrative embodiment of the present invention, when the contactless smartcard system 10 used for security applications, the reader 14 is usually located at the side of a door entrance.

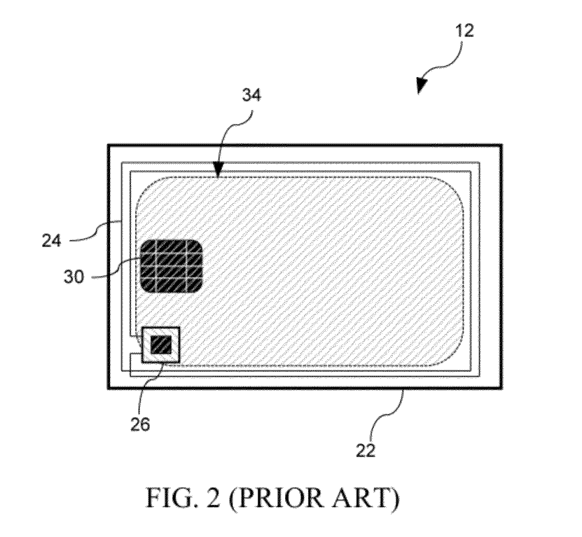

Now referring to FIG. 2, in addition to FIG. 1, the RFID proximity card 12, used in accordance with an illustrative embodiment of the present invention, comprises a credit card shaped substrate 22 with an RFID tag integrated therein. The RFID tag comprises an antenna 24 formed as a coil antenna disposed within the substrate 22 of the card 12, and a computing device or chip 26 comprising a smartcard secure microcontroller, or equivalent intelligence, for modulating and demodulating a radio-frequency (RF) signal for communication with the reader 14 and processing information, along with an internal memory for storing information. The RFID tag further comprises additional electronics (not shown) embedded within the substrate 22 to convert an induced alternating current 28 to direct current to power up the chip 26. Furthermore, some forms of contactless RFID proximity cards 12 are a dual interface type and comprise an additional communication interface in the form of a mechanical contact area 30 on the face of the smartcard 12 comprising metallic contacts connected to the chip 26. An RFID proximity card 12 comprising a mechanical contact area 30 may be physically inserted into a mechanical reader device (not shown) to align the mechanical contact area 30 with the contacts of the mechanical reader to create a communication link between the card 12 and the mechanical reader. During the lifespan of the card 12, the chip 26 and associated memory will be loaded with new information from a contactless reader 14 or a non-contactless reader (not shown) via the antenna 24, or via the contact plates 30, respectively. Such information may include, for example, transport rights or transport tokens, which may be validated at a card reading station before granting access to a restricted network or area, for example a transport network, verified for security or fraud purposes, debited when transport tokens are purchased, or displayed to a transport user to know the status of the transport tokens remaining on the card 12.

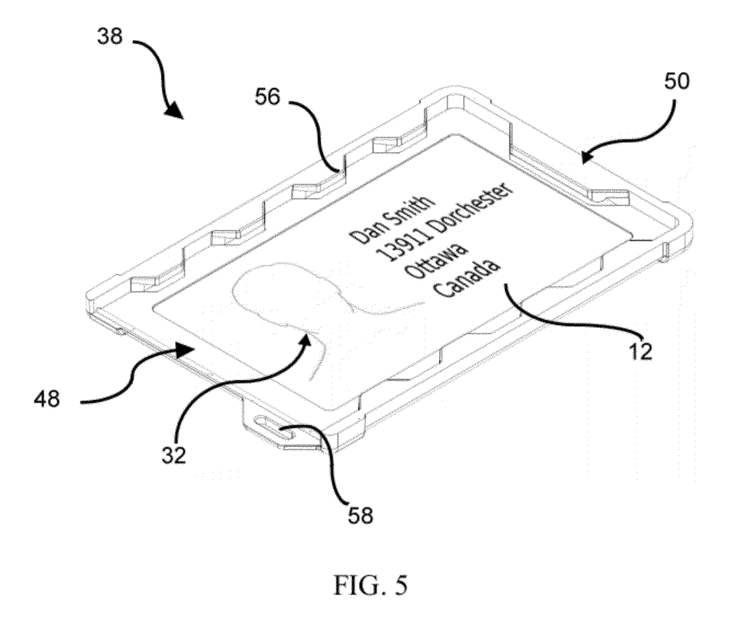

Still referring to FIG. 2 in addition to FIG. 1, the dimensions of a contactless smart card 12, in accordance with an illustrative embodiment of the present invention, approximate that of a credit card. Specifically, the ID-1 of ISO/IEC 7810 standard defines such dimensions as 85.60 mm (Length)×53.98 mm (Width)×0.76 mm (Thickness). The substrate 22 of the RFID proximity card 12 may be illustratively formed from a flexible material such as a dielectric substrate having first and second generally parallel planar surfaces on opposite sides thereof which also conforms to such the ISO/IEC 7810 standard. Typically in transit RFID proximity card applications, one side of the card 12 may comprise the mechanical contact area 30 while the other side may comprise additional visual validation information 32, such as a photo ID for seniors or students who benefit from a reduced transit fare, along with information such as the name and address of the card holder (see FIG. 5). Within the substrate 22 is integrated the antenna 24 which receives energy inductively coupled from the card reader 14 and which also transmits validation information thereto. Generally, the antenna 24 is designed as a coil antenna and comprises a sufficient number of turns (N) of a highly conductive material, such as copper, so it is sensitive to magnetic currents found in radio waves passing through its antenna loop area 34. While there are a large number of loop antenna designs for the antenna 24, all of which are aimed at converting an electromagnetic wave into a voltage it should be understood that, although the present invention is described using N-Turn square loop coil antenna which is as large as practicable and consistent with the dimension requirements of the contactless card 12, a variety of other antenna types which meet dimension requirements of the contactless card 12, the resonating inductance requirements for the chip 20 electronics, as well as the flux collecting requirement within the antenna loop area 34, may be employed.

Referring back to FIG. 1, the communication and powering of the smartcard 12 is achieved by interaction of the RFID proximity card 12 with the contactless interface 14 in the manner described herein below. In particular, such contactless smartcard readers 14 use radio frequencies to communicate with an RFID proximity card 12 to both read from and write data to the memory of the smart card 12. Power supplied via induction coupling with the smartcard 12 comes from a 13.56 MHz alternating magnetic field 18 generated by the antenna coil 16 of the reader 14. The reader 14 also comprises the various electronics 20 for, amongst other things, controlling an alternating current 36 provided to generate the alternating magnetic field 18 and for modulating and demodulating signals received and transmitted to and from the smartcard 12. In operation of the contactless smartcard system 10, the RFID proximity card 12 is positioned over the contactless reader 14 generally at a distance of approximately 0 to 3 inches, or to within 10 cm of the reader antenna 14. When the contactless smartcard 12 is brought within proximity of the card reader 14, the alternating magnetic field 18 is produced by a sinusoidal current 36 flowing through the reader antenna loop 16. Once the RFID proximity card 12 is correctly positioned within the alternating magnetic field 18, the alternating current 28 is induced in the card loop antenna 24.

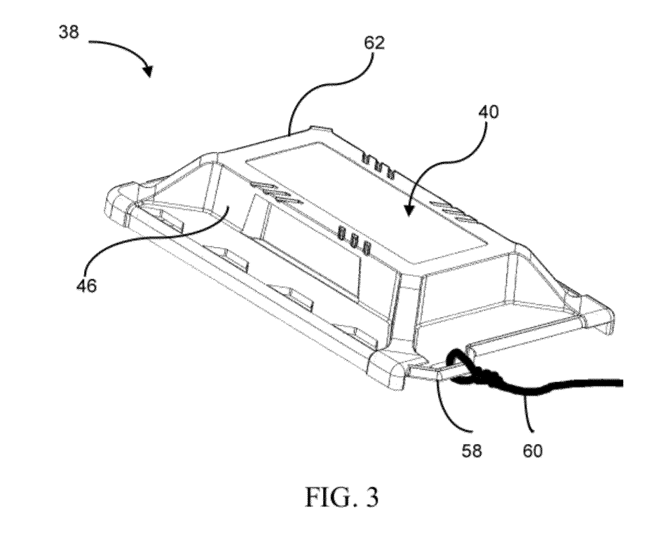

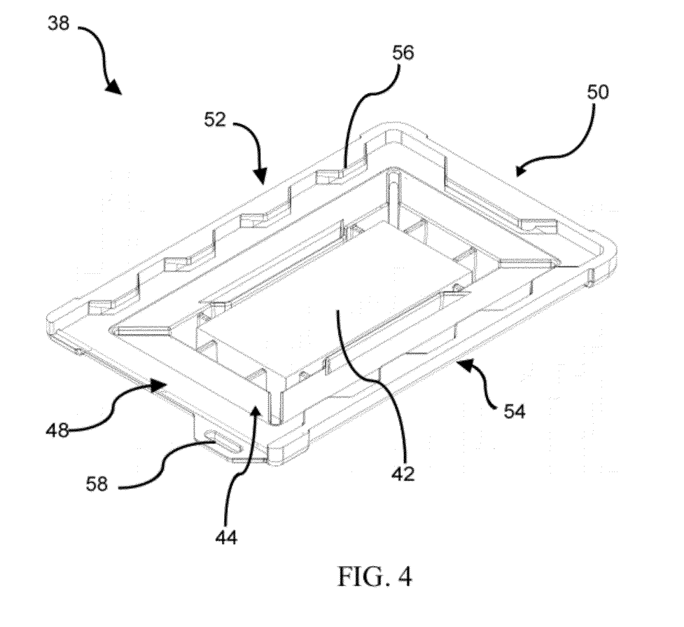

Referring now to FIG. 3 and FIG. 4, an illustrative embodiment of an RFID proximity card holder with flux directing means, generally referred to using the reference number 38, will now be described within the context of the contactless smartcard system 10. The card holder 38 comprises a body 40 adapted to receive an RFID proximity card 12, and a flux directing element 42 such that the flux directing element 42 is positioned substantially centered and above the plane parallel to the RFID proximity card loop antenna 24 when the proximity card 12 is received therein. The body 40 may be composed of a non-metallic light weight material such as injection molded plastic or the like. Furthermore, the body 40 comprises an open bottom 44, a hollow raised top portion 46 for receiving the flux directing element 42, an open side end 48 and a closed side end 50, as well as first 52 and second sides 54 and a series of protruding tabs 56 extending inwardly from the closed side end 50, and the first 52 and second sides 54. The body 40 further comprises a ring 58 or hook formed thereto through which a string or an attachment means 60 may be connected for securing the card holder 38 to an object, such as a bag, an article of clothing, or the like. The raised top portion 46 is illustratively embossed with chevron like gripping indentations 62 for providing traction to a holder's grip.

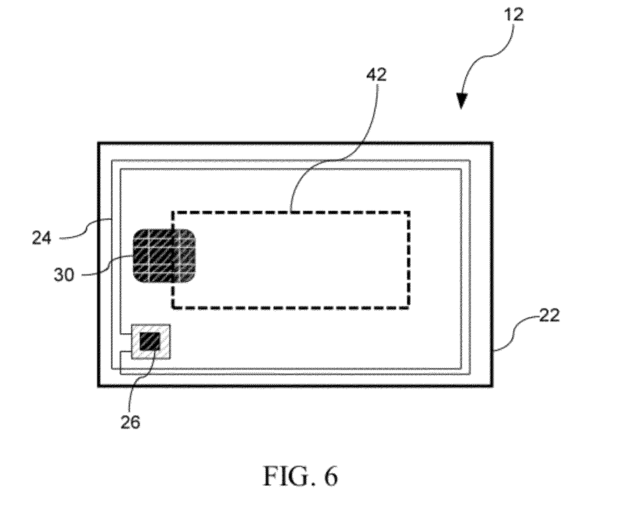

Referring now to FIG. 5 and FIG. 6, in addition to FIG. 3 and FIG. 4, the RFID proximity card holder with flux directing means 38 slidably receives the totality of the RFID proximity card 12 through its open side end 48 which is secured into place therein by the series of protruding tabs 56. The open side end 48 permits any validation information 32, such as a photo ID printed on the side of card 12, to be viewable when the card 12 is received within the card holder 38, and without any obstruction by the series of protruding tabs 56 to permit an additional visual validation, for instance by a bus driver or an access station transmit worker, to ensure the identity of the card holder matches the validation information 32. Once the card 12 is slid into the card holder 38 it may snap or click into place in a non-permanent manner such that the card 12 is protected from flexing and torsion by the structural rigidity provided for by the body 38. Such structural reinforcement will protect the bond between the embedded loop antenna 24 and the chip 26 from breakage should the card 12 be subjected to excessive bending and torsion flexing when, notably, card holders attempt to use their card 12 by pressing it on a card reader 14, and from the daily handling and storing of a card 12 in a purse, pocket, wallet, bag, or the like. Once secured into place within the card holder 38, the card 12 may be removed thereafter should the card 12 be required to be inserted into a contact mechanical reading machine or for storage in a wallet or the like.

Referring back to FIG. 3 and FIG. 4, the flux directing element 42 is comprised of a planer layer of a magnetic material with a high permeability capable of confining and guiding magnetic flux 18. For instance, the flux directing element 42 is illustratively composed of a ferromagnetic metal such as iron or ferromagnetic compounds such as ferrites having a high permeability relative to the surrounding air, which makes it capable of influencing the magnetic field lines 18 to be concentrated within its core and ultimately within the area antenna loop area 34. The flux directing element 42, while illustratively shaped as rectangular cube, may take on other forms as known to a person skilled in the art such that the magnetic flux 18 is sufficiently directed to within the antenna loop area 34. Additionally, the thickness of the flux directing element 42 may vary depending on different factors such as portability and weight, as well as the degree of influence the flux directing element 42 is designed to have on the flux 18. For instance, a flux directing element 42 having a thinner thickness may be preferred for lower cost, while a thicker flux directing element 40 may be preferable for increased interrogation distance.

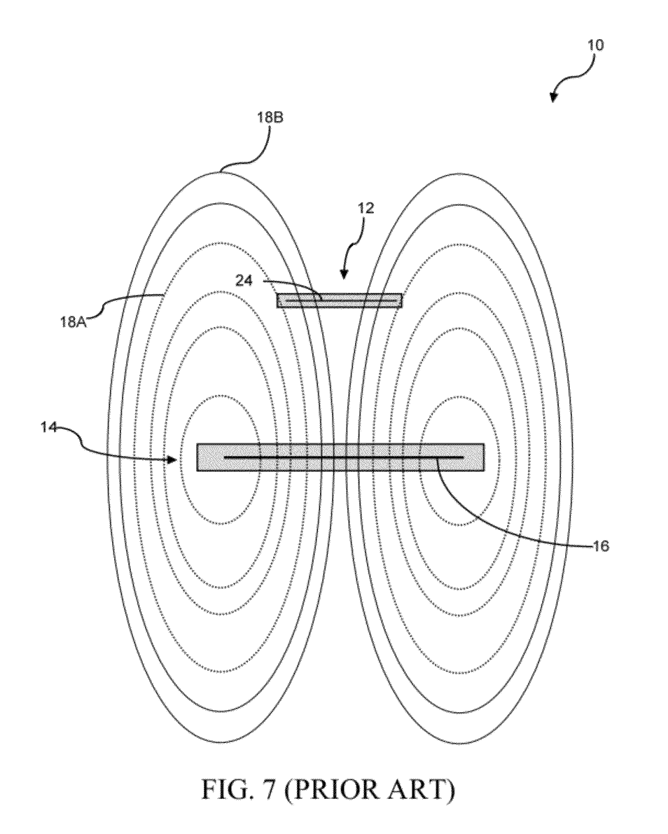

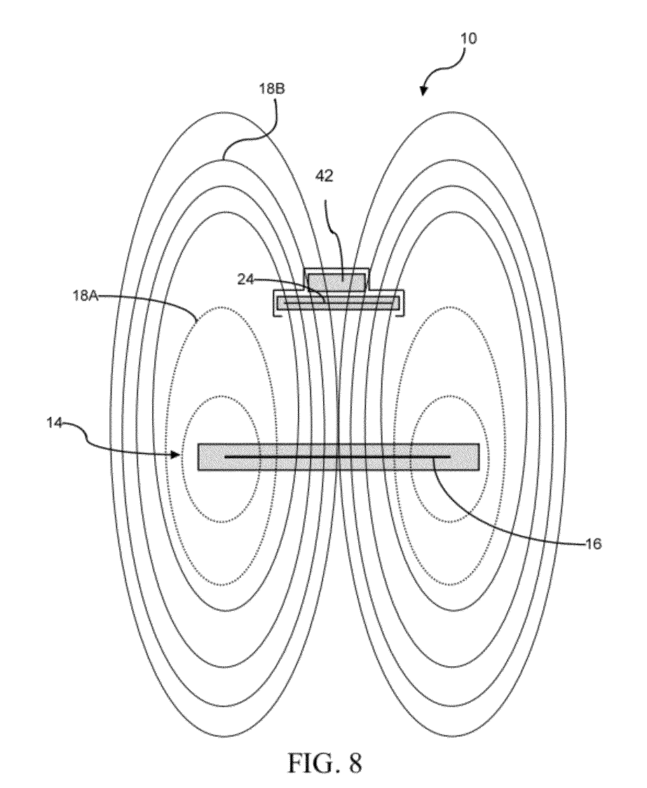

Now referring to FIG. 7 and FIG. 8, in addition to FIG. 6, in operation of the RFID proximity card holder with flux directing means 38, an RFID proximity card 12 is slid into the open side end 48 of the body 40 until it abuts the closed side end 50 and is snapped securely into place therein. Once the card 12 has been secured and is enclosed by the card holder 38, the flux directing element 42 is positioned relative to the loop antenna 24 such that it is centered within and above the antenna loop area 34 in a parallel plane. The high permeability of the flux directing element 42 relative to the surrounding air, causes the magnetic field lines 18A generated by the reader 14, which would not ordinarily pass through the antenna loop area 34 absent a flux directing element 42 as does the flux 18B, to be influenced and drawn into its core to thereby force the flux 18A passing in proximity to the card 12 to be concentrated within the antenna loop area 34 as a magnetic flux 18B. The increased flux 18B now focused to within the antenna loop area 34 allows a significant improvement in the magnetic coupling between the loop antenna of the RFID proximity card 12 and the reader antenna coil 16. Consequentially, the user of a proximity card 12 retrofitted with the RFID proximity card holder with flux directing means 36 will provide a more convenient experience for a card holder since the reading of the card 12 will appear to occur sooner on approach to the card reader 14, at a greater distance, and at less than optimal orientations. Furthermore, should a card 12 have to be recharged in a mechanical reading device employing the mechanical contact area 30, the RFID proximity card 12 is easily removable from within the card holder 38 by simply sliding the card out of the open side end 48.

In summary, the RFID proximity card holder 38 of the present invention improves and optimizes the interrogation orientation deviation and reading distance of an existing RFID proximity smartcard 12 by an RFID reader 14. The RFID proximity card holder 38 of the present invention is also capable of being non-permanently retrofitted to the existing RFID proximity smartcard 12. In particular, the existing RFID smartcard 12 may continue to be employed with existing mechanical contact reading machines for charging, reading, and the like that may require that the RFID proximity smartcard 12 be removed from the card holder 38. Furthermore, the non-permanent smartcard RFID holder 38 according to the present invention protects the RFID proximity card 12 from day-to-day wear and tear and simultaneously improves magnetic coupling between the RFID proximity card 12 and the RFID card reader 14. The RFID card holder 38 may also include the raised-up area 46 that a user can more easily grasp on to and which allows for improved positioning of the RFID card 12 onto the RFID reader 14.

Although the exemplary embodiments of the present invention are discussed with reference to RFID proximity smartcards used in the context of a mass public transportation system, other applications may include access control to buildings and other forms of smartcards such as student ID access cards, building access cards, taxis, tram ways, subways, electronic toll collection, security access or other types of payment systems, and it can be modified, without departing from the spirit and nature of the subject invention as defined in the appended claims.

1. A card holder for an RFID proximity card comprising a coil loop antenna with an area for interfacing with a flux generating RFID proximity card reader, the card holder comprising:
a flux directing means; and
a housing for containing said flux directing means and receiving the RFID proximity card;
wherein when the RFID proximity card is received within said housing, said flux directing means influences the flux generated by the RFID proximity reader such that the flux is directed to within the area of the coil loop antenna.

2. The card holder of claim 1, wherein said flux directing means comprises a magnetic material.

3. The card holder of claim 1, wherein said housing has an open bottom to allow validation information disposed on a surface of the RFID proximity card to be visible when the RFID proximity card is received within said housing.

4. The card holder of claim 1, wherein when the RFID proximity card is received within said housing, said flux directing means is positioned substantially centered and above a plane parallel to the coil loop antenna.

5. The card holder of claim 1, wherein said housing has an open end to allow the RFID proximity card to be slidably received within said housing.

6. A card holder for an RFID proximity card comprising a coil loop antenna with an area for interfacing with a flux generating RFID proximity card reader, the card holder comprising:
a magnet; and
a housing for containing said magnet along a first plane and receiving the RFID proximity card along a second plane spaced apart from the first plane;
wherein when the RFID proximity card is received within said housing, said magnet influences the flux generated by the RFID proximity reader such that the flux is directed to within the area of the coil loop antenna.
